(19) United States
(12) Patent Application Publication
(10) Pub. No.: US 2025/0379280 A1
(43) Pub. Date: Dec. 11, 2025

(54) OPPOSED TERMINAL CELL CONFIGURATION

(71) Applicant: Our Next Energy, Inc., Novi, MI (US)

(72) Inventors: Nathan Saliga, Clarkston, MI (US); Vignesh Sekar, Farmington Hills, MI (US); Qingcheng Zeng, San Jose, CA (US)

(21) Appl. No.: 19/231,952

(22) Filed: Jun. 9, 2025

Related U.S. Application Data
(60) Provisional application No. 63/657,700, filed on Jun. 7, 2024.

(51) Int. Cl. H01M 10/653; H01M 10/0525; H01M 10/6556; H01M 50/15; H01M 50/209; H01M 50/507; H01M 50/521; H01M 50/55; H01M 50/588

(52) U.S. Cl. CPC H01M 10/653; H01M 10/6556; H01M 50/15; H01M 50/209; H01M 50/507; H01M 50/521; H01M 50/55; H01M 50/588; H01M 10/0525

(57) ABSTRACT

A cell includes a cell housing, at least one end cap, at least three terminals, the at least three terminals including at least one positive terminal and at least one negative terminal. The cell further includes a coupling device for each of the at least three terminals, the coupling device including a busbar and a thermal interface material, the busbar being in contact with and disposed between the terminal and the thermal interface material, the busbar and the thermal interface material thermally coupling the terminal to a top or bottom cold plate. The thermal interface material further electrically insulates the top or bottom cold plate from the terminal.

### BACKGROUND

### Technical Field

The present disclosure generally relates to cells and more particularly to a cell configuration that incorporates opposed terminal arrangements and multiple terminals to facilitate improved current flow and thermal management.

### Description of the Related Art

Battery cells are traditionally used in many technologies including in electric vehicles and energy storage systems.

Battery may often face challenges related to thermal management and current distribution, especially under high load conditions. Existing cells typically involve the use of dual-terminal configurations to transmit energy to a load. This can sometimes limit the ability to evenly distribute current and dissipate heat. Furthermore, the integration of these cells into larger battery packs often necessitates complex management systems to ensure operational reliability and safety.

### BRIEF SUMMARY

According to an embodiment, a cell includes at least one end cap, at least three terminals, the at least three terminals including at least one positive terminal and at least one negative terminal. The cell further includes a coupling device for each of the at least three terminals, the coupling device including a busbar and a thermal interface material, the busbar being in contact with and disposed between the terminal and the thermal interface material, the busbar and the thermal interface material thermally coupling the terminal to a top or bottom cold plate. The thermal interface material further electrically insulates the top or bottom cold plate from the terminal.

In one embodiment, the cell includes at least three terminals are all disposed on one top or bottom end cap of the at least one end cap.

In one embodiment, the cell includes a first end cap disposed at a first end of the cell and a second end cap disposed at a second end of the cell opposite the first end. At least one of the first end cap and the second end cap includes at least two terminals of opposite polarities.

In one embodiment, the cell includes a first end cap disposed at a first end of the cell and a second end cap disposed at a second end of the cell opposite the first end. At least one of the first end cap and the second end cap includes at least two terminals of opposite polarities.

According to an embodiment, a battery pack includes a plurality of cells, each cell including at least one end cap, at least three terminals, the at least three terminals including at least one positive terminal and at least one negative terminal. The cell further includes a coupling device for each of the at least three terminals, the coupling device including a busbar and a thermal interface material, the busbar being in contact with and disposed between the terminal and the thermal interface material, the busbar and the thermal interface material thermally coupling the terminal to a top or bottom cold plate. The thermal interface material further electrically insulates the top or bottom cold plate from the terminal.

According to an embodiment, a method includes providing a cell housing, providing at least one end cap, and disposing at least three terminals on the at least one end cap, the at least three terminals including at least one positive terminal and at least one negative terminal. In the method, a coupling device is provided for each of the at least three terminals by arranging a busbar of the coupling device to be in contact with and disposed between the terminal and a thermal interface material of the coupling device, such that the busbar and the thermal interface material thermally couple the terminal to a top or bottom cold plate. In the method, the thermal interface material electrically insulates the top or bottom cold plate from the terminal.

### BRIEF DESCRIPTION OF THE DRAWINGS

To easily identify the discussion of any particular element or act, the most significant digit or digits in a reference number refer to the figure number in which that element is first introduced.

FIG. 1A depicts a perspective view of a cell from one end in accordance with an illustrative embodiment.

FIG. 1B depicts a perspective view of a cell from another end in accordance with an illustrative embodiment.

FIG. 2 depicts a perspective view of a battery pack in accordance with an illustrative embodiment.

FIG. 3 depicts a perspective view of a plurality of cells in accordance with an illustrative embodiment.

FIG. 4 depicts a perspective view of a battery pack illustrating a zoomed in view of a portion of the battery pack in accordance with an illustrative embodiment.

FIG. 5 depicts a perspective view of a busbar and thermal interface material in accordance with an illustrative embodiment.

FIG. 6 depicts a perspective view of a plurality of cells and corresponding busbars and thermal interface materials in accordance with an illustrative embodiment.

FIG. 7 depicts a coupling mechanism in accordance with an illustrative embodiment.

FIG. 8 depicts a perspective view of a busbar and thermal interface material in accordance with an illustrative embodiment.

FIG. 9 depicts a perspective view of a battery pack housing in accordance with an illustrative embodiment.

FIG. 10 depicts a perspective view of a bottom cold plate in accordance with an illustrative embodiment.

FIG. 11 depicts a routine for manufacturing a cell in accordance with an illustrative embodiment.

FIG. 12A depicts a top view of a cell with four terminals in accordance with an illustrative embodiment.

FIG. 12B depicts a side cross sectional view of a cell with four terminals in accordance with an illustrative embodiment.

FIG. 13A depicts a top view of a cell with three terminals in accordance with an illustrative embodiment.

FIG. 13B depicts a side cross sectional view of a cell with three terminals in accordance with an illustrative embodiment.

FIG. 14 depicts a side cross sectional view of a cell with terminals of opposite polarities on at least one end cap in accordance with an illustrative embodiment.

FIG. 15 depicts a side cross sectional view of a cell with terminals of opposite polarities on at least one end cap in accordance with an illustrative embodiment.

FIG. 16 depicts a routine for manufacturing a cell in accordance with an illustrative embodiment.

FIG. 17 depicts a functional block diagram of a computer hardware platform in accordance with an illustrative embodiment.

### DETAILED DESCRIPTION

### Overview

In the following detailed description, numerous specific details are set forth by way of examples to provide a thorough understanding of the relevant teachings. However, it should be apparent that the present teachings may be practiced without such details. In other instances, well-known methods, procedures, and/or components have been described at a relatively high-level, without detail, to avoid unnecessarily obscuring aspects of the present teachings.

In one aspect, spatially related terminology such as “front,” “back,” “top,” “bottom,” “beneath,” “below,” “lower,” above,” “upper,” “side,” “left,” “right,” and the like, is used with reference to the orientation of the Figures being described. Since components of embodiments of the disclosure can be positioned in a number of different orientations, the directional terminology is used for purposes of illustration and is in no way limiting. Thus, it will be understood that the spatially relative terminology is intended to encompass different orientations of the device in use or operation in addition to the orientation depicted in the figures. For example, if the device in the figures is turned over, elements described as “below”, or “beneath” other elements or features would then be oriented “above” the other elements or features. Thus, for example, the term “below” can encompass both an orientation that is above, as well as below. The device may be otherwise oriented (rotated 90 degrees or viewed or referenced at other orientations) and the spatially relative descriptors used herein should be interpreted accordingly.

As used herein, the terms “coupled” and/or “electrically coupled” are not meant to mean that the elements must be directly coupled together-intervening elements may be provided between the “coupled” or “electrically coupled” elements. In contrast, if an element is referred to as being “directly connected” or “directly coupled” to another element, there are no intervening elements present. The term “electrically connected” refers to a low-ohmic electric connection between the elements electrically connected together.

Although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

Example embodiments are described herein with reference to illustrations that are schematic illustrations of idealized or simplified embodiments (and intermediate structures). As such, variations from the shapes of the illustrations as a result, for example, of manufacturing techniques and/or tolerances, may be expected.

It is to be understood that other embodiments may be used, and structural or logical changes may be made without departing from the spirit and scope defined by the claims. The description of the embodiments is not limiting. In particular, elements of the embodiments described hereinafter may be combined with elements of different embodiments.

For the sake of brevity, conventional techniques related to battery cells and their fabrication may or may not be described in detail herein. Moreover, the various tasks and process steps described herein can be incorporated into a more comprehensive procedure or process having additional steps or functionality not described in detail herein.

Turning now to an overview of technologies that generally relate to the present teachings, large format battery cells such as large format lithium iron phosphate (LFP) battery cells.

Traditionally, large format lithium iron phosphate (LFP) battery cells often face challenges related to inefficient thermal management and limited current flow capabilities, which can lead to reduced cycle life, and potential safety risks during high current operations such as direct current fast charging (DCFC). These issues are particularly critical in applications requiring high energy density and rapid charging capabilities, such as electric vehicles and energy storage systems.

The illustrative embodiments disclose cell configurations that incorporate opposed terminal designs with advanced thermal coupling and electrical insulation strategies. This configuration not only improves the thermal management by effectively dissipating heat from busbars but also enhances the electrical performance by reducing electrical resistance and enabling higher current flows through the use of multiple terminals. More specifically, the illustrative embodiments disclose a cell designed with a plurality of terminals, such as at least four terminals. The plurality of terminals increases current conductivity and thermal management relative to a similar cell without a smaller number of terminals. For example, two positive terminals may be disposed on one end of the cell and two negative terminals may be disposed on the opposite end of the cell, each positioned near/in close proximity to the top and bottom of their respective end caps. The configuration may allow for an increased cross-sectional area for conducting high currents during direct current fast charging (DCFC) events and enables effective thermal connection of busbars to the pack level cold plates. The terminals facilitate current distribution while minimizing resistance. As used herein, the terms cold plate, top cold plate, bottom cold plate, and similar terms generally refer to a thermal management system such as a coolant manifold, or a coolant tube, or any other device that is designed to dissipate heat from one end to another and thus can dissipate heat away from the cells when coupled to the cells.

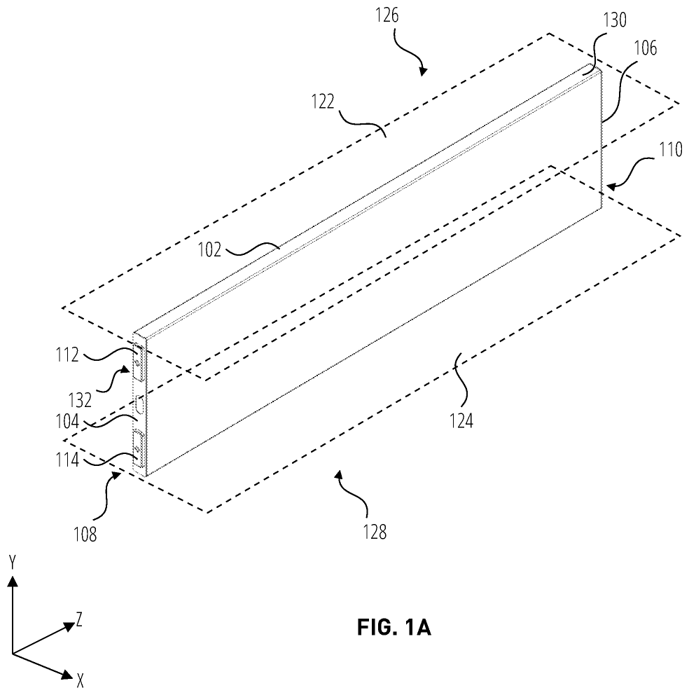

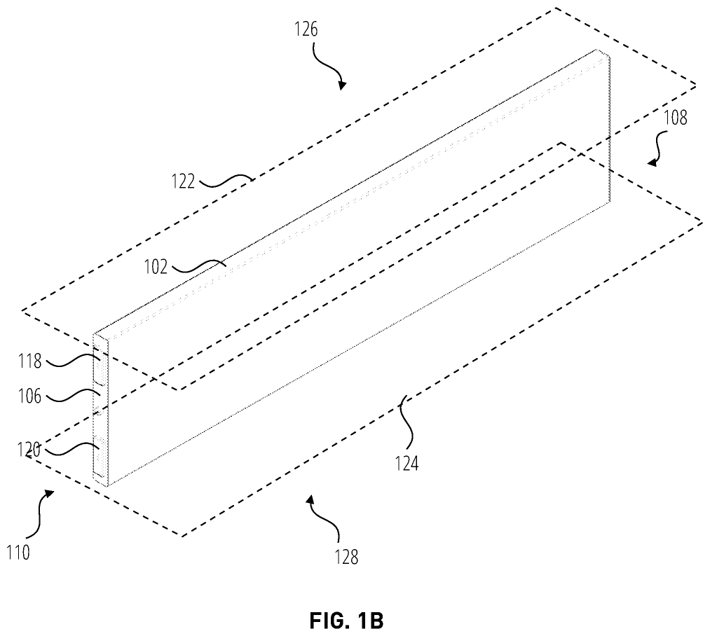

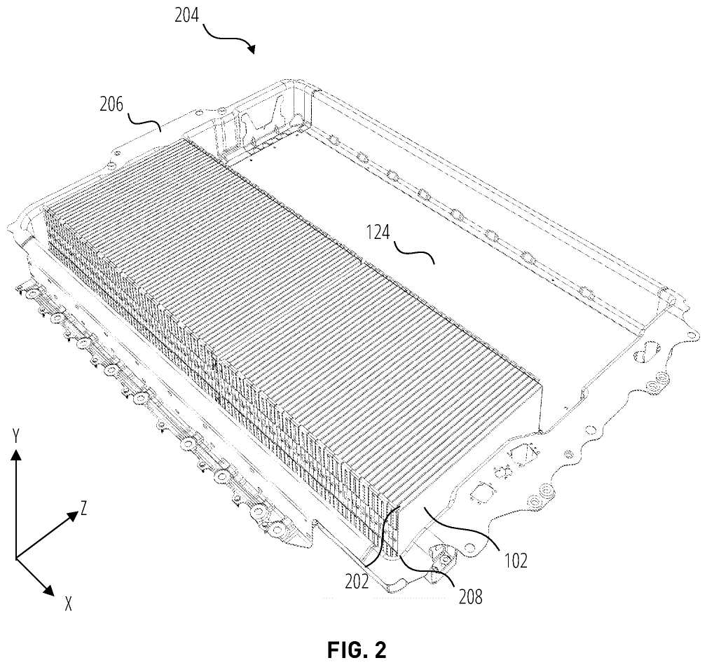

With reference to FIG. 1A and FIG. 1B, the cells 102 described herein generally include a cell housing 130, at least one end cap (e.g., first end cap 104, second end cap 106), and at least three terminals 132 (e.g., first positive terminal 112, second positive terminal 114, first negative terminal 118, second negative terminal 120). The at least three terminals include at least one positive terminal and at least one negative terminal. The cells 102 further include a coupling device 202 (see FIG. 2) for each of the at least three terminals, the coupling device 202 includes a busbar and a thermal interface material described hereinafter. The busbar is in contact with and disposed between the terminal and the thermal interface material, and the busbar and the thermal interface material thermally couple the terminal to a top cold plate 122 or a bottom cold plate 124. The thermal interface material further electrically insulates the top cold plate 122 or bottom cold plate 124 from the terminal.

In one embodiment, the at least three terminals are all disposed on one top or bottom end cap of the at least one end cap as described hereinafter. In another embodiment, the cell 102 includes a first end cap 104 disposed at a first end 108 of the cell, a second end cap 106 disposed at a second end 110 of the cell opposite the first end, and at least one of the first end cap 104 and the second end cap 106 includes at least two terminals of opposite polarities. However, in another embodiment, the cell includes the first end cap 104 disposed at a first end 108 of the cell, the second end cap disposed at the second end 110 of the cell opposite the first end, and at least one of the first end cap 104 and the second end cap 106 includes at least two terminals of the same polarity. Other technical features may be readily apparent to one skilled in the art from the following figures, descriptions, and claims.

Turning to FIG. 1A, the figure illustrates a perspective view of a cell 102 from a first end 108 in accordance with an illustrative embodiment wherein the end caps include at least two terminals of the same polarity. The cell 102 comprises a first end cap 104 disposed at a first end 108 of the cell 102, the first end cap 104 comprising a first positive terminal 112 and a second positive terminal 114. The cell 102 further comprises a second end cap 106 disposed at a second end 110 of the cell opposite the first end, the second end cap 106 comprising a first negative terminal 118 and a second negative terminal 120. Thus, two positive terminals may be positioned near the top (first side 126) and bottom (second side 128) of the end cap, the top or first side 126 referring to a wall of the cell perpendicular to both a plane in which the first end cap 104 lies (YX-plane), and a plane in which a profile or largest wall by area of the cell 102 lies (YZ-plane). The bottom (second side 128) is disposed opposite the top. The first end 108 and the second end 110 are parallel to the YX plane.

Likewise, two negative terminals are located on the opposite end (second end 110) of the cell, the two negative terminals being similarly positioned near the top and bottom of the second end cap 106, complementing the positive terminals' layout and enhancing current flow.

At least the doubling of the number of positive and negative terminals doubles the available cross-sectional area of terminals and halves the resistance of the terminal connections, while providing a comparatively more uniform current distribution/density across the electrode tab (for example, a minimum of a 30% improvement).

The first positive terminal 112 may be thermally coupled to a top cold plate 122 that is positioned at the first side 126 of the cell 102, and the second positive terminal 114 is thermally coupled to a bottom cold plate 124 that is positioned at the second side 128 of the cell 102 opposite the first side 126. Further, the first positive terminal 112 is electrically insulated from the top cold plate 122 and the second positive terminal 114 is electrically insulated from the bottom cold plate 124. The thermal coupling and electrical insulation may be achieved with a combined or discrete coupling mechanism as described hereinafter.

FIG. 1B illustrates a perspective view of the cell 102 from a direction of the second end 110 end. As discussed herein, the first negative terminal 118 may be thermally coupled to the top cold plate 122 and the second negative terminal 120 may be thermally coupled to the bottom cold plate 124. Further, the first negative terminal 118 may be electrically insulated from the top cold plate 122 and the second negative terminal 120 may be electrically insulated from the bottom cold plate 124.

Efficient thermal management may reduce the risk of overheating and thermal runaway, thereby enhancing the overall safety of a battery pack comprising one or more cells. The opposed terminal design may also allow for redundant connections for a high current path, allowing continued pack operation if a connection breaks.

FIG. 2 illustrates a perspective view of a battery pack 204 in accordance with an illustrative embodiment. The battery pack 204 can comprise a plurality of the cells such as the cells of FIG. 1A/FIG. 1B. In the example, the battery pack 204 comprises a plurality of cells 102, each cell 102 comprising the first end cap 104 disposed at the first end 108 of the cell 102, the first end cap 104 comprising the first positive terminal 112 and the second positive terminal 114, though this is not meant to be limiting. For example, the cells of the battery pack can comprise any of the cells described herein such as a cell comprising at least one end cap and at least three terminals. However, in the illustrative example of FIG. 2 each cell 102 comprises the second end cap 106 disposed at the second end cap of the cell 102 opposite the first end cap, the second end cap 106 comprising the first negative terminal 118 and the second negative terminal 120. Likewise, the first positive terminal 112 of the cells 102 of the battery pack 204 may be thermally coupled to and electrically insulated from top cold plate 122 of the battery pack 204 and the second positive terminal of the cells 102 of the battery pack 204 may be thermally coupled and electrically insulated from to the bottom cold plate 124 of the battery pack 204. For illustration purposes, FIG. 2 does not show the top cold plate 122. At least most of the cells 102 of the battery pack 204 may comprise a combined or discrete coupling device 202, as described hereinafter, for thermal coupling and electric insulation.

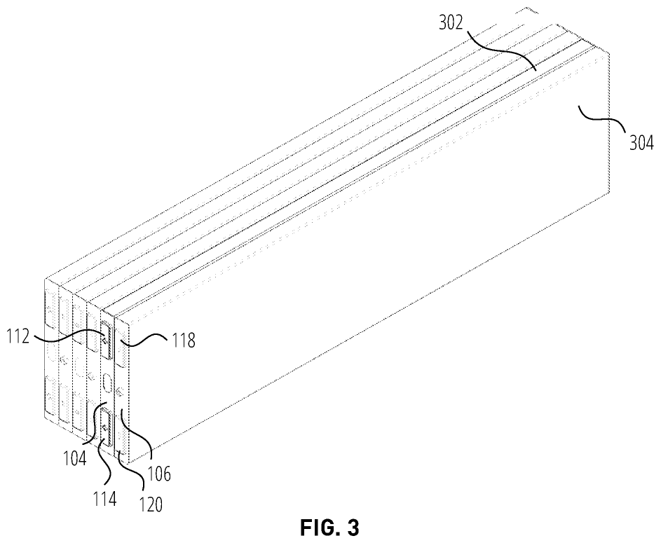

The cells 102 of the battery pack 204 may be arranged in any number of series and/or parallel connections. For example, as shown in FIG. 3, the cells can be arranged in an alternating fashion wherein the first end cap 104 of a first cell 302 is on a same end of the battery pack as a second end cap 106 of a second cell 304 adjacent to the first cell. By arranging the cells 102 in such an alternating fashion, a series connection of the cells 102 can be achieved. Of course, this is not meant to be limiting as other arrangements, such as a non-alternating parallel arrangement of cells, can be achieved in light of the descriptions herein.

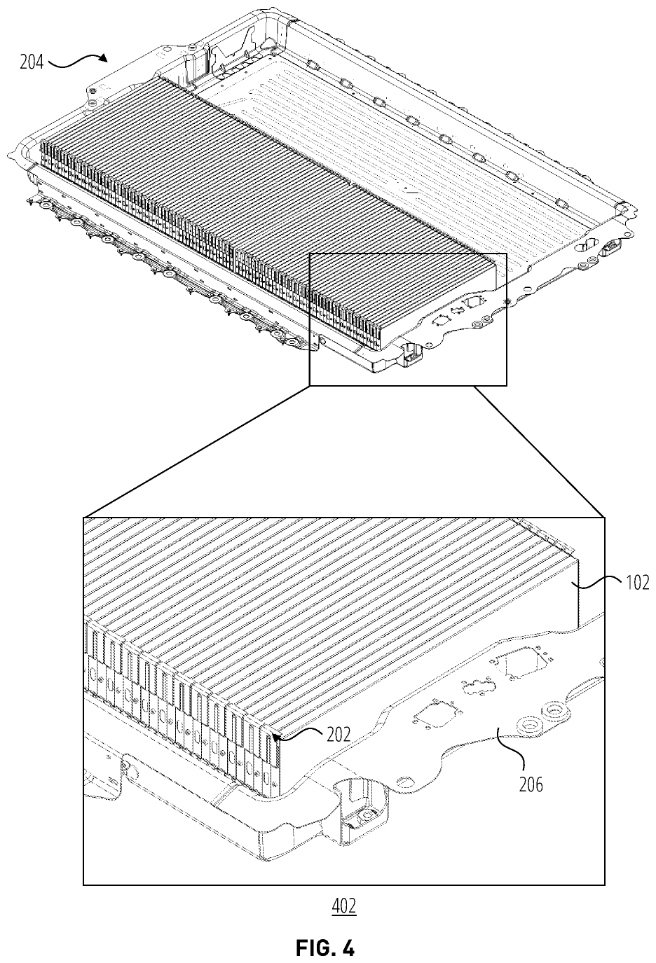

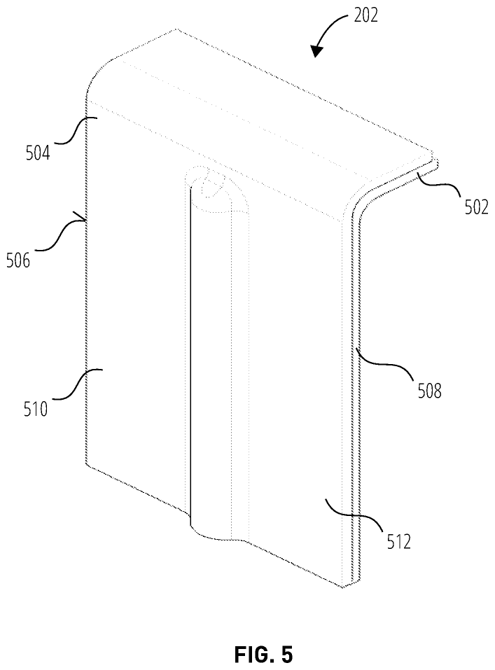

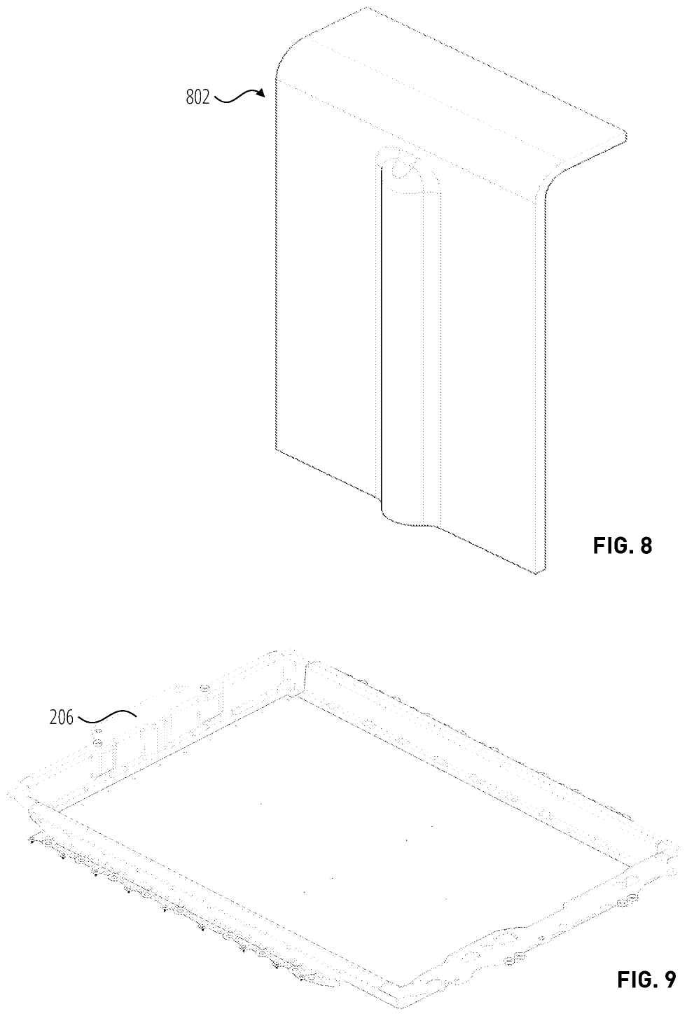

FIG. 4 illustrates a zoomed-in view 402 of a portion of the battery pack 204 and a battery pack housing 206 of a battery pack 204 depicting the coupling device 202 that electrically couples adjacent cells together, thermally couples the cells to cold plates and electrically insulates the cold plates from the cells. In the figure, two adjacent cells are coupled with the coupling device 202, some possible structures of which are discussed in FIG. 5 and FIG. 8. Of course, this is not mean to be limiting as any plurality of cells can be coupled together in view of the descriptions herein.

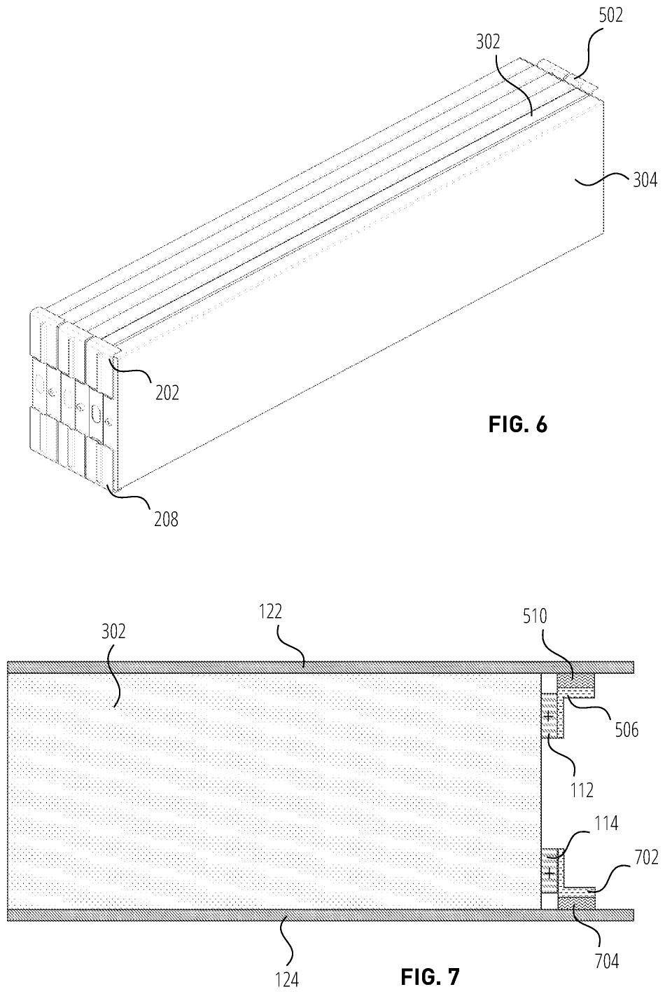

FIG. 5 illustrates a perspective view of a coupling device 202 comprising a common busbar 502 and a common thermal interface material 504. The common busbar 502 and the common thermal interface material 504 may be initially separate, be part of individual cells and may be joined together when connecting cells of a battery pack in a series and/or parallel connection. The common busbar 502 may alternatively manufactured as a single entity. The common busbar 502 may electrically couple terminals together, such as a first terminal to a second terminal. For example, in a series connection of the cells of FIG. 3, the common busbar 502 of the coupling device 202 may electrically couple the first positive terminal 112 of the first cell 302 to the first negative terminal 118 of the second cell 304 as is illustrated in FIG. 6. Another coupling device 208 may further couple a second positive terminal 114 of the first cell 302 to the second negative terminal 120 of the second cell 304.

Since the common busbar 502 may be initially separate, the common busbar 502 can comprise a first busbar of first cell 506, and a first busbar of second cell 508 as shown in FIG. 5. Likewise, the coupling device 202 can further comprise a common thermal interface material 504 that electrically insulates the top cold plate 122 and/or bottom cold plate 124 from the electrical activity of the cells or busbars. The common thermal interface material 504 can further thermally couple the busbars to the cold plates for heat dissipation. The common thermal interface material 504 can also be initially discrete and this comprise a first thermal interface material of first cell 510 and the first thermal interface material of second cell 512 or may alternatively be manufactured as a single entity.

FIG. 7 shows another cell configuration illustrating an example coupling mechanism. In general, the cell (e.g. first cell 302) comprises a first busbar (e.g. first busbar of first cell 506) in contact with and disposed between the first positive or negative terminal (e.g., first positive terminal 112 in the case of FIG. 7) and a first thermal interface material (e.g., first thermal interface material of first cell 510 in the case of FIG. 7). The first busbar and the first thermal interface material thermally couple the first positive or negative terminal to the top cold plate 122.

A second busbar (e.g., second busbar of first cell 702) can be in contact with and disposed between the second positive or negative terminal (e.g., second positive terminal 114) and a second thermal interface material (e.g., second thermal interface material of first cell 704). The second busbar and the second thermal interface material thermally couple the second positive or negative terminal to the bottom cold plate 124. The thermal coupling ensures efficient thermal connection of the busbars to the pack level cold plate allowing for effective heat dissipation during DCFC events, maintaining optimal cell temperature and preventing thermal runaway. The design may further prolong the cell's lifespan and ensure consistent performance, even under demanding operational conditions.

In an embodiment, the thermal interface materials comprise two layers: a first electrical insulation layer adjacent to the busbar and configured to provide electrical insulation from the busbar; and a heat conducting material configured to transfer heat from the busbar to the top or bottom cold plates respectively. Generally, the heat conducting material can dissipate and improve the transfer of heat out of electronics devices by placing the material between a heat-generating end and a heat spreading substrate. The first electrical insulation layer can be, for example, Kapton tape. The heat conducting material can be, for example, a thermally conductive silicone.

In another embodiment, the thermal interface materials comprise a single layer of heat conducting material that is filled with bond line spacer spheres. More specifically, spheres or microspheres can used as bond line spacers to provide precise spacing between parts. The spherical shape and consistency of dimensions may not require aligning the particles in a specific orientation, and the dimensions can be precise, making microspheres ideal for precision bondline spacers in a liquid adhesive or epoxy.

In a further embodiment, the busbars can be coated with a high temperature di-electric (robust to ˜600 C, such as robust to 600 C+/−10%) on the side adjacent to the thermal interface material to provide electrical isolation from the pack enclosure. The busbars can be designed to connect via laser weld with the cell terminals, ensuring minimal electrical resistance and optimal conductivity. The busbars are thermally bonded with the pack level cold plate, facilitating efficient heat transfer away from the cell during high-power events.

In another embodiment, a capacity of the cell is greater than 130 Ah. For example, to achieve 10 min fast charge, a cell may have to charge at up to 5.5 C rate. At this rate, it may be challenging to manage >700 A through a single terminal and busbar. A double terminal design may however enable a capacity greater than 130 Ah. Further, a direct current fast charging (DCFC) rating of the cell is greater than 700 A. Unlike for cells described herein, currents above 700 A may be challenging to manage in conventional busbars such as a single aluminum busbar within the battery pack due to heat generation. The increased cross-sectional area for current flow allows the cell to handle higher currents without significant heating or energy loss. The cell can be a prismatic comprising an LFP chemistry. One or more other positive terminals and corresponding negative terminals can further be arranged on the first end cap and second end cap respectively with the one or more other positive terminals and corresponding negative terminals being thermally coupled to the top or bottom cold plates and electrically insulated from the top or bottom cold plates.

FIG. 8 illustrates another perspective view of a joined busbar and thermal interface material 802 wherein the busbar and thermal interface material are combined into a single manufactured entity to be used as the coupling device 202.

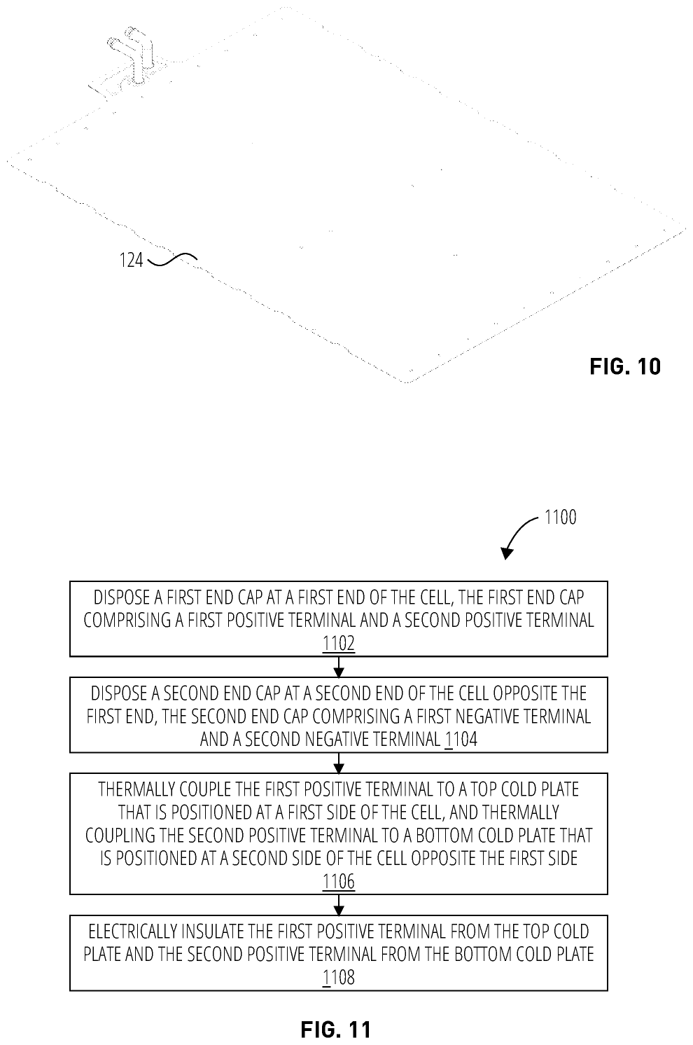

FIG. 9 shows a perspective view of a part of a battery pack housing 206 of the battery pack 204. The housing is a robust housing, providing structural integrity and protection for the internal components. An example bottom cold plate 124 is depicted in FIG. 10. The top cold plate and bottom cold plate comprise a material that enables the plates to draw heat away from one end to another.

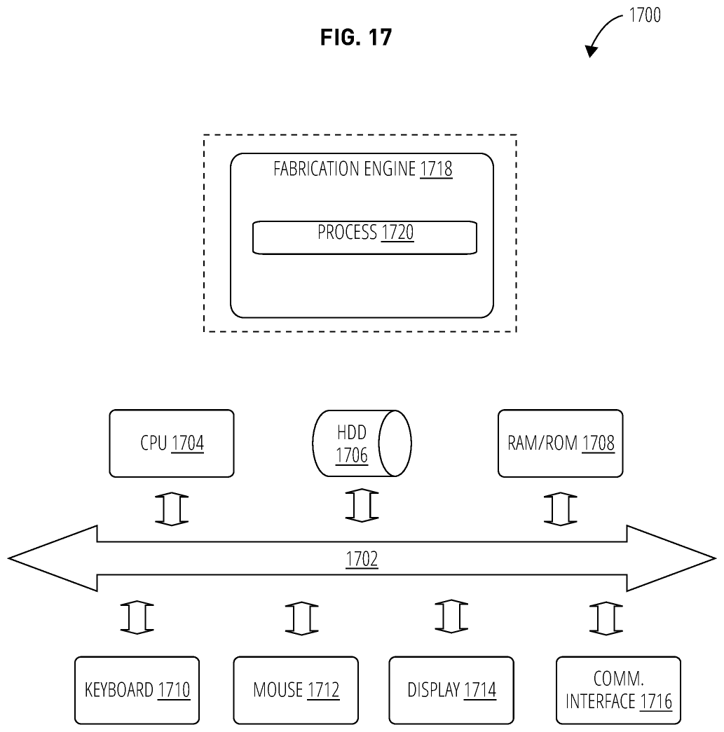

Turning now to FIG. 11, a routine 1100 for manufacturing a cell 102 to be performed by a fabrication engine such as the fabrication engine 1718 of FIG. 17 is illustrated. In block 1102, the fabrication engine 1718 disposes a first end cap 104 at a first end 108 of the cell 102, the first end cap 104 comprising a first positive terminal 112 and a second positive terminal 114. In block 1104, fabrication engine 1718 disposes a second end cap 106 at a second end 110 of the cell 102 opposite the first end cap, the second end cap 106 comprising a first negative terminal 118 and a second negative terminal 120. In block 1106, fabrication engine 1718 thermally couples the first positive terminal 112 to a top cold plate 122 that is positioned at a first side 126 of the cell 102, and thermally couples the second positive terminal 114 to a bottom cold plate 124 that is positioned at a second side 128 of the cell 102 opposite the first side 126. In block 1108, fabrication engine 1718 electrically insulates the first positive terminal 112 from the top cold plate 122 and the second positive terminal 114 from the bottom cold plate 124. A combined or discrete coupling device 202 can be used for the thermal coupling and electrical insulation. The routine 1100 may also be repeated for other cells to generate a plurality of cells for use in manufacturing a battery pack 204.

As discussed herein, the cell 102 can include at least three terminals 132, the at least three terminals including at least one positive terminal and at least one negative terminal.

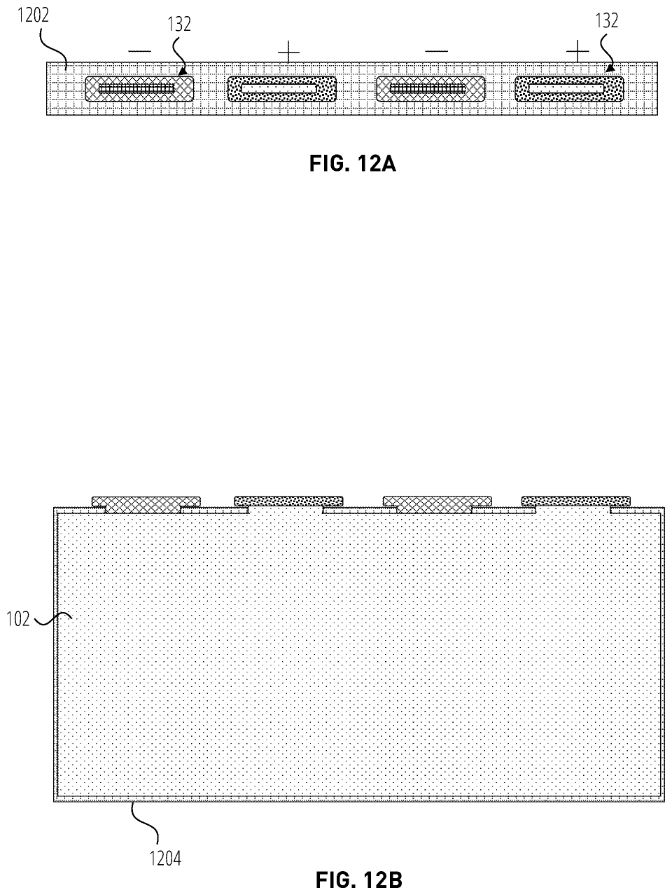

FIG. 12A-FIG. 12B illustrate an embodiment including four terminals 132 wherein all the terminals 132 are disposed on a top end cap 1202 that is parallel to the XZ plane. At least one of the terminals is a positive terminal and at least one of the terminals is a negative terminal. Each of the terminals 132 can have a corresponding coupling device comprising a busbar and a thermal interface material, the busbar being in contact with and disposed between the terminal and the thermal interface material, the busbar and the thermal interface material thermally coupling the terminal to a top cold plate, and the thermal interface material electrically insulating the top cold plate from the terminal. The coupling devices for adjacent terminals can be combined or separate as discussed herein.

In another embodiment, the terminals can be disposed at the bottom end cap 1204.

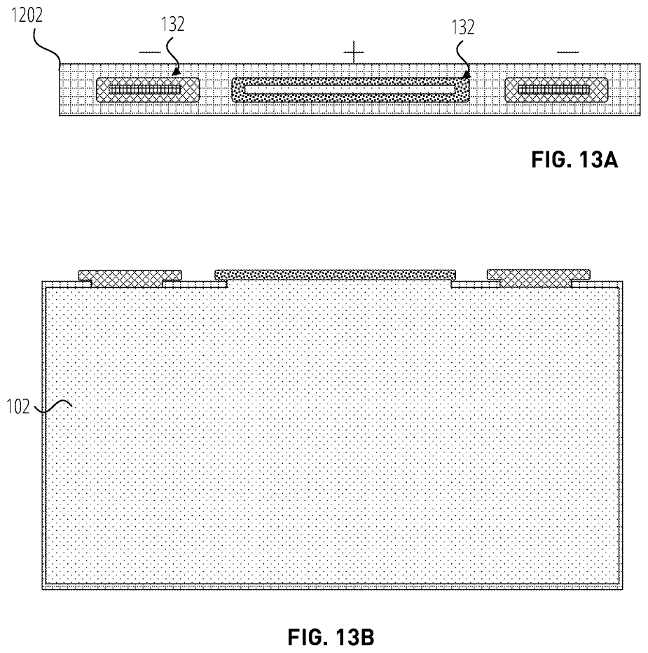

Likewise, FIG. 13A-FIG. 13B illustrate another embodiment including three terminals 132 wherein the three terminals 132 are disposed on the top end cap 1202 and thus can be coupled to the top cold plate through corresponding coupling devices 202. Terminals of a plurality of adjacent cells can be coupled together via coupling devices 202 in any number of ways to obtain desired series and/or parallel connections while maintaining electrical insulation of the terminals from the cold plates and dissipating heat from the busbars concurrently.

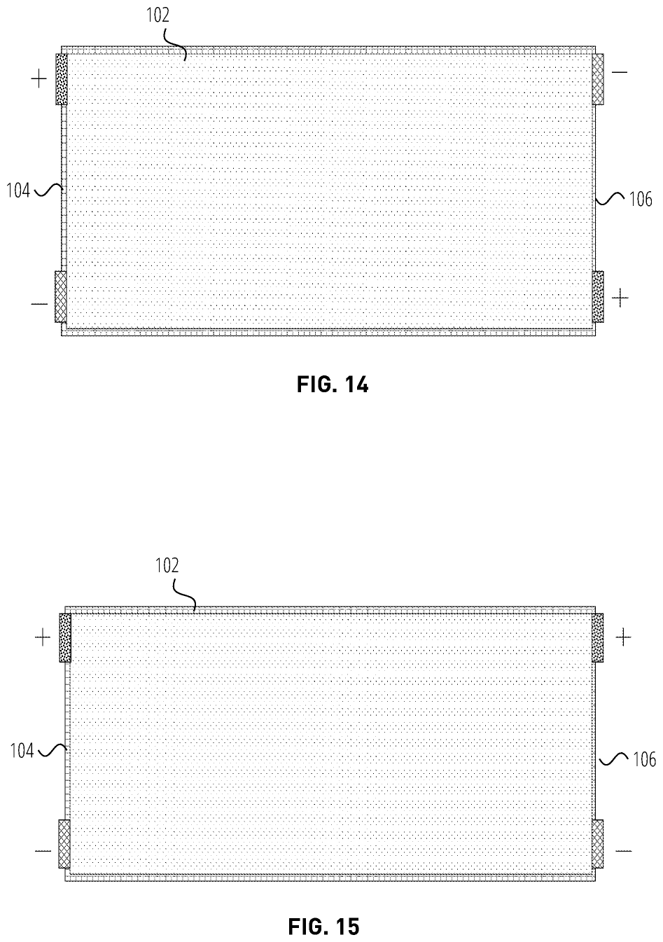

Turning now to FIG. 14-FIG. 15, another embodiment comprises a first end cap 104 disposed at a first end of the cell; and a second end cap 106 disposed at a second end of the cell 102 opposite the first end. In both FIG. 14 and FIG. 15, one or both of the first end cap 104 and the second end cap 106 comprise at least two terminals of opposite polarities illustrated by the “+” and “−” signs respectively.

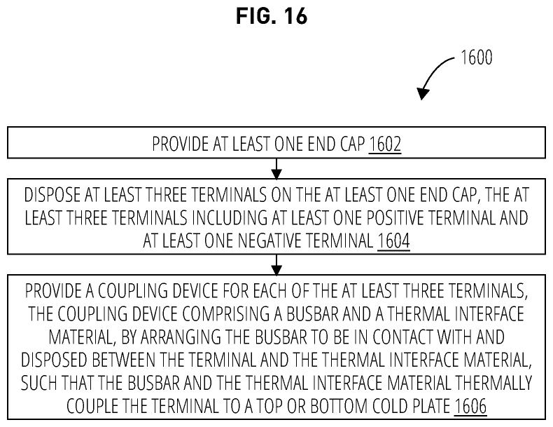

FIG. 16 illustrates a general routine 1600 for manufacturing a cell. In block 1602, fabrication engine 1718 provides at least one end cap. In block 1604, fabrication engine 1718 disposes at least three total terminals on the at least one end cap, the at least three terminals include at least one positive terminal and at least one negative terminal. In block 1606, fabrication engine 1718 provides a coupling device for each of the at least three terminals, the coupling device includes a busbar and a thermal interface material. This may be achieved by arranging the busbar to be in contact with and disposed between the terminal and the thermal interface material, such that the busbar and the thermal interface material thermally couple the terminal to a top or bottom cold plate. The thermal interface material also electrically insulates the top or bottom cold plate from the terminal.

### Example Computer Platform

As discussed above, functions relating to systems and methods for fabricating a cell and/or a battery pack. FIG. 17 is a functional block diagram illustration of a computer hardware platform that can be used to control various aspects of a suitable computing environment in which the process discussed herein can be controlled. While a single computing device is illustrated for simplicity, it will be understood that a combination of additional computing devices, program modules, and/or combination of hardware and software can be used as well. The computer platform 1700 may include a central processing unit (CPU) 1704, a hard disk drive (HDD) 1706, random access memory (RAM) and/or read only memory (ROM) 1708, a keyboard 1710, a mouse 1712, a display 1714, and a communication interface 1716, which are connected to a system bus 1702.

In one embodiment, the hard disk drive (HDD) 1706, has capabilities that include storing a program that can execute various processes, such as the fabrication engine 1718, in a manner described herein. The fabrication engine 1718 may have various modules configured to perform different functions. For example, there may be a process module 1720 configured to control the different manufacturing processes discussed herein and others.

For the sake of brevity, conventional techniques related to making and using aspects of the disclosure may or may not be described in detail herein. In particular, various aspects of manufacturing and computing systems and specific programs to implement the various technical features described herein may be well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or system. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram, or the steps (or operations) described therein without departing from the spirit of the disclosure. For instance, the actions can be performed in a differing order, or actions can be added, deleted, or modified.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” and similar terms can include a range of ±8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A cell comprising:
a cell housing;
at least one end cap;
at least three terminals, the at least three terminals including at least one positive terminal and at least one negative terminal;
a coupling device for each of the at least three terminals, the coupling device comprising a busbar and a thermal interface material, the busbar being in contact with and disposed between the terminal and the thermal interface material, the busbar and the thermal interface material thermally coupling the terminal to a top or bottom cold plate,
wherein thermal interface material electrically insulates the top or bottom cold plate from the terminal.

2. The cell of claim 1, wherein the at least three terminals are all disposed on one top or bottom end cap of the at least one end cap.

3. The cell of claim 1, further comprising:
a first end cap disposed at a first end of the cell;
a second end cap disposed at a second end of the cell opposite the first end,
wherein at least one of the first end cap and the second end cap comprises at least two terminals of opposite polarities.

4. The cell of claim 1, further comprising:
a first end cap disposed at a first end of the cell;
a second end cap disposed at a second end of the cell opposite the first end,
wherein at least one of the first end cap and the second end cap comprises at least two terminals of a same polarity.

5. The cell of claim 4, wherein:
the first end cap comprises a first positive terminal and a second positive terminal;
the second end cap comprises a first negative terminal and a second negative terminal;
the first positive terminal is thermally coupled to the top cold plate that is positioned at a first side of the cell, and the second positive terminal is thermally coupled to the bottom cold plate that is positioned at a second side of the cell opposite the first side,
wherein the first positive terminal is electrically insulated from the top cold plate and the second positive terminal is electrically insulated from the bottom cold plate.

6. The cell of claim 5, wherein the first negative terminal is thermally coupled to the top cold plate and the second negative terminal is thermally coupled to the bottom cold plate,
wherein the first negative terminal is electrically insulated from the top cold plate and the second negative terminal is electrically insulated from the bottom cold plate.

7. The cell of claim 1, wherein the thermal interface material further comprises:
a first electrical insulation layer adjacent to the busbar and configured to provide electrical insulation of the top or bottom cold plates from the busbar; and
a heat conducting material configured to transfer heat from the busbar to the top or bottom cold plates.

8. The cell of claim 7, wherein the heat conducting material comprises a thermally conductive silicone.

9. The cell of claim 7, wherein the electrical insulation layer comprises Kapton.

10. The cell of claim 1, wherein the thermal interface material comprises:
a single layer of heat conducting material that is filled with bond line spacer spheres, the heat conducting material being configured to transfer heat from the busbar to the top or bottom cold plates respectively.

11. The cell of claim 1, wherein the busbar is coated with a high temperature di-electric.

12. The cell of claim 1, wherein a capacity of the cell is greater than 130 Ah.

13. The cell of claim 1, wherein a direct current fast charging (DCFC) rating of the cell is greater than 700 A.

14. The cell of claim 1, wherein the cell is a prismatic cell comprising a lithium-ion phosphate (LFP) chemistry.

15. A battery pack comprising a plurality of cells, each cell comprising:
a cell housing;
at least one end cap;
at least three terminals, the at least three terminals including at least one positive terminal and at least one negative terminal;
a coupling device for each of the at least three terminals, the coupling device comprising a busbar and a thermal interface material, the busbar being in contact with and disposed between the terminal and the thermal interface material, the busbar and the thermal interface material thermally coupling the terminal to a top or bottom cold plate,
wherein thermal interface material electrically insulates the top or bottom cold plate from the terminal.

16. The battery pack of claim 15, wherein for each cell:
the at least three terminals are all disposed on one top or bottom end cap of the at least one end cap.

17. The battery pack of claim 15, wherein each cell further comprises:
a first end cap disposed at a first end of the cell;
a second end cap disposed at a second end of the cell opposite the first end,
wherein at least one of the first end cap and the second end cap comprises at least two terminals of opposite polarities.

18. The battery pack of claim 15, wherein each cell further comprises:
a first end cap disposed at a first end of the cell;
a second end cap disposed at a second end of the cell opposite the first end,
wherein at least one of the first end cap and the second end cap comprises at least two terminals of a same polarity.

19. The battery pack of claim 15, wherein:
the busbar of a first cell is electrically coupled to another busbar of one or more adjacent cells, and
by virtue of the thermal interface materials of the first cell and the one or more other adjacent cell, the busbars of the first cell and one or more other adjacent cells are electrically insulated from the top or bottom cold plates.

20. A method of manufacturing a cell comprising:
providing a cell housing;
providing at least one end cap;
disposing at least three terminals on the at least one end cap, the at least three terminals including at least one positive terminal and at least one negative terminal;
providing a coupling device for each of the at least three terminals, the coupling device comprising a busbar and a thermal interface material, by arranging the busbar to be in contact with and disposed between the terminal and the thermal interface material, such that the busbar and the thermal interface material thermally couple the terminal to a top or bottom cold plate,
wherein thermal interface material electrically insulates the top or bottom cold plate from the terminal.
